(19) United States
(12) Patent Application Publication
(10) Pub. No.: US 2026/0161642 A1
(43) Pub. Date: Jun. 11, 2026

(54) DYNAMIC CONTEXT-BASED CONVERSATIONAL SEARCH OVER ENTERPRISE GRAPH DATABASES

(71) Applicant: International Business Machines Corporation, Armonk, NY (US)

(72) Inventors: Avirup Saha, Kolkata (IN); Shashank Mujumdar, Nagpur (IN)

(21) Appl. No.: 18/947,055

(22) Filed: Nov. 14, 2024

(51) Int. Cl. G06F 16/2452; G06F 16/901

(52) U.S. Cl. CPC G06F 16/24522; G06F 16/9024

(57) ABSTRACT

Examples described herein provide a computer-implemented method that includes receiving a natural language query from a user as a user query. The method further includes identifying a subgraph from the enterprise graph database that covers an intent of the user query. The method further includes translating the natural language query by mapping the natural language query to corresponding nodes, attributes, and relationships in the subgraph. The method further includes providing recommendations to the user by generating values for the corresponding nodes, attributes, and relationships in the subgraph. The method further includes dynamically generating a cypher statement based on a repository of template patterns covering various query types. The method further includes iteratively correcting errors in the generated cypher statement to ensure correctness.

### BACKGROUND

The present disclosure relates to computing environments, and more specifically, to dynamic context-based conversational search over enterprise graph databases.

Graph databases are a type of database designed to handle complex, interconnected data, where relationships between entities are as important as the data itself. Unlike traditional relational databases, which organize data in rows and columns, graph databases use a flexible structure of nodes, edges, and properties. Nodes can be used to represent entities, such as people, locations, or products. Each node can have properties-key-value pairs storing information about the entity, such as a user's name or age. Edges can be used to represent relationships between nodes. For example, if two people are friends, an edge (or link) might connect their respective nodes. Each edge can also have properties, such as the date a friendship started. Properties are key-value pairs associated with both nodes and edges, adding details, such as individual's name or the type of relationship between nodes.

This structure allows graph databases to model real-world networks effectively, making them useful for applications such as social networks (e.g., representing friends, followers, or connections between users), recommendation engines (e.g., modeling user preferences and linking them to similar products or people), fraud detection (e.g., tracing suspicious transactions across complex webs of connections), knowledge graphs (e.g., connecting related pieces of information to improve search engines or AI applications), and/or the like, including combinations and/or multiples thereof.

Enterprise graph databases are specialized graph databases designed to handle the scalability, security, and integration demands of large organizations. They cater to high-demand applications that require the efficient handling of vast datasets, complex relationships, and real-time querying. For example, enterprise graph databases employ large schemas with complex node relationships and defined attributes having millions of nodes and edges.

### SUMMARY

According to an embodiment, a computer-implemented method for dynamic context-based conversational search over an enterprise graph database is provided. The method includes receiving a natural language query from a user as a user query. The method further includes identifying a subgraph from the enterprise graph database that covers an intent of the user query. The method further includes translating the natural language query by mapping the natural language query to corresponding nodes, attributes, and relationships in the subgraph. The method further includes providing recommendations to the user by generating values for the corresponding nodes, attributes, and relationships in the subgraph. The method further includes dynamically generating a cypher statement based on a repository of template patterns covering various query types. The method further includes iteratively correcting errors in the generated cypher statement to ensure correctness.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to an embodiment;

FIG. 2 illustrates a block diagram of a system for dynamic context-based conversational search over enterprise graph databases, according to an embodiment;

FIG. 3A illustrates flow diagram of a method for offline graph subschema selection, according to an embodiment;

FIG. 3B illustrates flow diagram of a method for online graph subschema selection, according to an embodiment;

FIG. 4 illustrates a flow diagram of a method for search value recommendation, according to an embodiment;

FIG. 5 illustrates tables for user preference selection, according to an embodiment;

FIG. 6 illustrates pseudo-code for query pattern-based fewshot generation, according to an embodiment;

FIG. 7 illustrates pseudo-code for instruction-based fewshot learning, according to an embodiment;

FIG. 8 illustrates a flow diagram of a method for performing self-healing validation, according to an embodiment;

FIG. 9 illustrates a flow diagram of a method for conversational search of a graph database, according to an embodiment; and

FIGS. 10A and 10B together illustrate a flow diagram of a method for dynamic context-based conversational search over enterprise graph databases, according to an embodiment.

### DETAILED DESCRIPTION

One or more embodiments described herein provides for identity provider agnostic departmental multi-tenancy management of storage resource.

According to an embodiment, a computer-implemented method for dynamic context-based conversational search over an enterprise graph database is provided. The method includes receiving a natural language query from a user as a user query. The method further includes identifying a subgraph from the enterprise graph database that covers an intent of the user query. The method further includes translating the natural language query by mapping the natural language query to corresponding nodes, attributes, and relationships in the subgraph. The method further includes providing recommendations to the user by generating values for the corresponding nodes, attributes, and relationships in the subgraph. The method further includes dynamically generating a cypher statement based on a repository of template patterns covering various query types. The method further includes iteratively correcting errors in the generated cypher statement to ensure correctness. One or more embodiments described herein improves the functioning of a computer by enhancing the efficiency, accuracy, and user-friendliness of querying enterprise graph databases through dynamic context-based conversational search. Dynamically generating a cypher statement based on a repository of template patterns covering various query types allows for the efficient creation of complex queries without manual intervention. This automation streamlines the querying process, making it faster and reducing the likelihood of errors that can occur with manual query writing. Iteratively correcting errors in the generated cypher statement to ensure correctness introduces a self-healing mechanism that enhances the reliability and accuracy of the querying process. This iterative correction process minimizes the risk of query failures and ensures that the final cypher statement is syntactically and semantically correct.

According to another embodiment, a computer system is provided that includes a processor set, one or more computer-readable storage media, and program instructions stored on the one or more computer-readable storage media to cause the processor set to perform operations for dynamic context-based conversational search over an enterprise graph database. The operations include receiving a natural language query from a user as a user query. The operations further include identifying a subgraph from the enterprise graph database that covers an intent of the user query. The operations further include translating the natural language query by mapping the natural language query to corresponding nodes, attributes, and relationships in the subgraph. The operations further include providing recommendations to the user by generating values for the corresponding nodes, attributes, and relationships in the subgraph. The operations further include dynamically generating a cypher statement based on a repository of template patterns covering various query types. The operations further include iteratively correcting errors in the generated cypher statement to ensure correctness. One or more embodiments described herein improves the functioning of a computer by enhancing the efficiency, accuracy, and user-friendliness of querying enterprise graph databases through dynamic context-based conversational search. Dynamically generating a cypher statement based on a repository of template patterns covering various query types allows for the efficient creation of complex queries without manual intervention. This automation streamlines the querying process, making it faster and reducing the likelihood of errors that can occur with manual query writing. Iteratively correcting errors in the generated cypher statement to ensure correctness introduces a self-healing mechanism that enhances the reliability and accuracy of the querying process. This iterative correction process minimizes the risk of query failures and ensures that the final cypher statement is syntactically and semantically correct.

According to yet another embodiment, a computer program product is provided that includes one or more computer-readable storage media and program instructions stored on the one or more computer-readable storage media to perform operations for dynamic context-based conversational search over an enterprise graph database. The operations include receiving a natural language query from a user as a user query. The operations further include identifying a subgraph from the enterprise graph database that covers an intent of the user query. The operations further include translating the natural language query by mapping the natural language query to corresponding nodes, attributes, and relationships in the subgraph. The operations further include providing recommendations to the user by generating values for the corresponding nodes, attributes, and relationships in the subgraph. The operations further include dynamically generating a cypher statement based on a repository of template patterns covering various query types. The operations further include iteratively correcting errors in the generated cypher statement to ensure correctness. One or more embodiments described herein improves the functioning of a computer by enhancing the efficiency, accuracy, and user-friendliness of querying enterprise graph databases through dynamic context-based conversational search. Dynamically generating a cypher statement based on a repository of template patterns covering various query types allows for the efficient creation of complex queries without manual intervention. This automation streamlines the querying process, making it faster and reducing the likelihood of errors that can occur with manual query writing. Iteratively correcting errors in the generated cypher statement to ensure correctness introduces a self-healing mechanism that enhances the reliability and accuracy of the querying process. This iterative correction process minimizes the risk of query failures and ensures that the final cypher statement is syntactically and semantically correct.

One or more embodiments includes validating the generated cypher statement. Validating the generated cypher statement ensures that the query adheres to the correct syntax, entity mappings, and schema structure. This validation process significantly reduces the likelihood of query errors and failures, enhancing the reliability and accuracy of the querying process. As a result, users can trust that the results returned from the enterprise graph database are correct and relevant to their natural language query.

In one or more embodiments, validating the generated cypher statement includes performing a multi-step validation pipeline. Performing a multi-step validation pipeline allows for comprehensive error checking and correction at multiple levels. This approach ensures that the cypher statement is not only syntactically correct but also semantically accurate and aligned with the database schema. By identifying and correcting errors at different stages, the method improves the overall robustness and effectiveness of the query generation process, leading to more reliable and accurate query results.

In one or more embodiments, the multi-step validation pipeline includes performing a syntax validation, an entity validation, and a schema validation. Including syntax validation, entity validation, and schema validation in the multi-step validation pipeline ensures that the generated cypher statements are thoroughly checked for errors. Syntax validation ensures correct formatting, entity validation confirms the existence and correct mapping of entities, and schema validation checks conformity to the database schema. This comprehensive validation process reduces the need for manual intervention and correction, streamlining the querying process and making it more efficient.

One or more embodiments includes enabling multi-turn conversational interactions by supporting follow-up queries and continuously refining the cypher statement based on user preferences. Enabling multi-turn conversational interactions allows users to refine their queries through follow-up questions and feedback. This interactive approach improves the user experience by maintaining context and continuity across multiple interactions, leading to more precise data retrieval. Such embodiments can adapt to user preferences and provide more accurate and relevant responses over time, enhancing the overall effectiveness of the querying process.

In one or more embodiments, providing the recommendations to the user is generated through a mapping of the natural language query to a subgraph in a graph schema of the enterprise graph database. Providing recommendations through the mapping of the natural language query to a subgraph in the graph schema ensures that the user's intent is accurately captured and represented within the database structure. This mapping process enhances the precision and relevance of the query results, leading to more accurate data retrieval. By providing contextually relevant suggestions, the system helps users refine their queries and achieve better outcomes.

In one or more embodiments, the recommendations provided to the user include search values utilizing the corresponding nodes, attributes, and relationships in the subgraph. Providing search values as recommendations helps to disambiguate the user's intent and refine the query. This aspect improves the overall user experience by offering contextually relevant suggestions, which can guide the user towards more precise queries. As a result, such embodiments can deliver more accurate and relevant query results, enhancing the effectiveness of the querying process.

In one or more embodiments, the recommendations provided to the user include natural language query translations of the natural language query utilizing the corresponding nodes, attributes, and relationships in the subgraph. Providing natural language query translations as recommendations helps users understand how their queries are interpreted and mapped to the database structure. This transparency enhances user confidence in the system and allows for more effective query refinement. By offering clear and contextually relevant translations, such embodiments improve the accuracy and relevance of the query results, leading to a better overall user experience.

In modern computing environments, querying graph databases efficiently remains a significant challenge. Enterprise graph databases employ large schemas with complex node relationships and defined attributes having millions of nodes and edges, making querying a challenging task. Users typically manually write complex cypher statements to query such graph databases, which is cumbersome and infeasible for many users. An important feature for these databases is the ability to query them using natural language input from the user.

Existing solutions for querying graph databases with natural language input have several limitations. Basic rule-based systems require manual creation of rules for each new schema to match simple one-to-one node relationships based on keywords identified in the user query. Large language model (LLM)-based solutions struggle to generalize on new schemas for queries beyond single matches and are prone to hallucinations over node attributes, values, and relationships, as well as incorrect syntax. Additionally, LLM-based solutions are often limited by the context length of the input model, which is a significant issue given the large enterprise schemas. Furthermore, there is no mechanism to ensure the generated cypher statements are correct, and no user input or feedback is considered in the generation process.

One or more embodiments described herein addresses these shortcomings by enabling dynamic generation of cypher statements with self-healing capabilities to support conversational search over enterprise graph databases with large and complex schemas based on user preferences. One or more embodiments automatically maps user intent to a subgraph and translates the user's natural language query to include appropriate queries mapped to corresponding nodes, attributes, and relationships in the identified subgraph. One or more embodiments provides recommendations dynamically generated through mapping of user query intent to the subgraph, identifying the appropriate nodes, attributes, and relationships, and generating corresponding values in the format present in the graph database. One or more embodiments also identifies syntax, entity, and schema-related errors in generated cyphers and iteratively self-heals the cypher statement to prevent inaccuracies, supporting multi-turn conversations through an agentic workflow.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

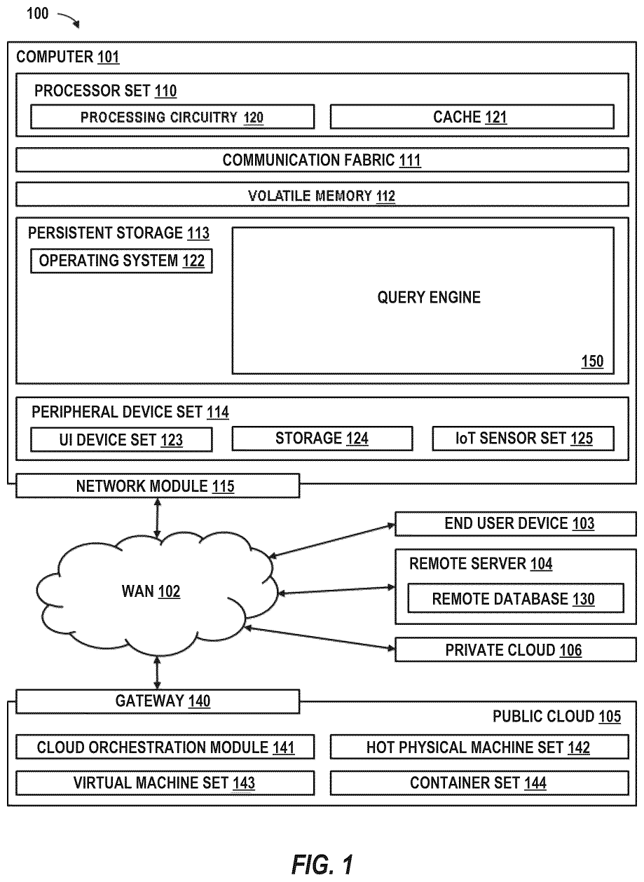

FIG. 1 illustrates a computing environment 100, according to an embodiment. Computing environment 100 contains an example of an environment for the execution of at least some of the computer code involved in performing the inventive methods, such as a query engine 150 for dynamic context-based conversational search over enterprise graph databases. In addition to the query engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the query engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the query engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the query engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The query engine 150 provides for dynamic context-based conversational search over enterprise graph databases. Features and functionality of the query engine 150 are now described in more detail with reference to the remaining figures but are not so limited.

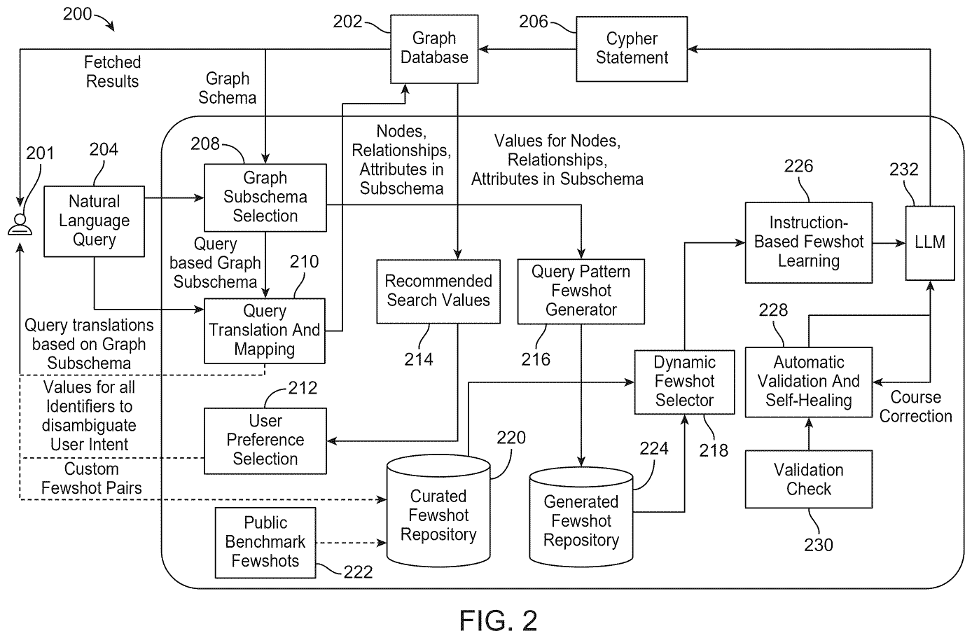

FIG. 2 illustrates a block diagram of a system 200 for dynamic context-based conversational search over a graph database 202, according to an embodiment. The graph database 202 may be an enterprise graph database according to one or more embodiments. The system 200 includes several components and workflows to process a natural language query 204 and generate a corresponding cypher statement 206 for querying a graph database.

A user 201 provides the natural language query 204, which is a natural language input directed towards performing a query of the graph database 202. The natural language query 204 is processed by the system 200 to generate the cypher statement 206, where the system 200 includes the following components.

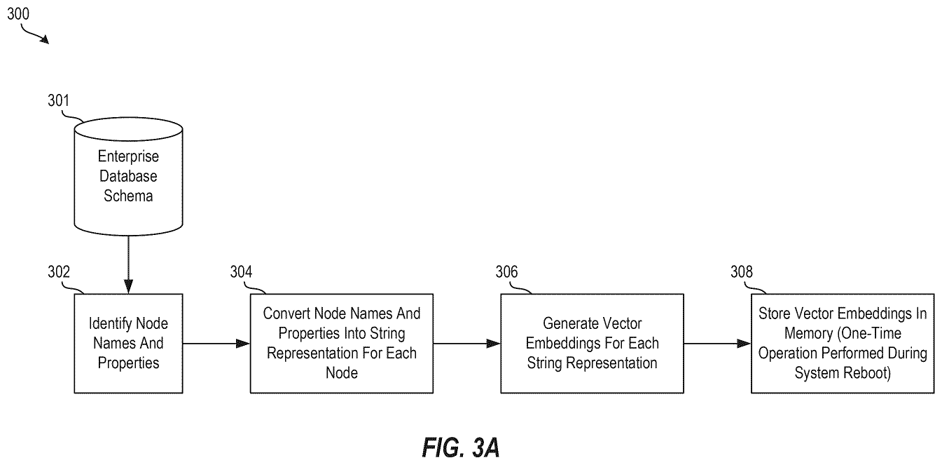

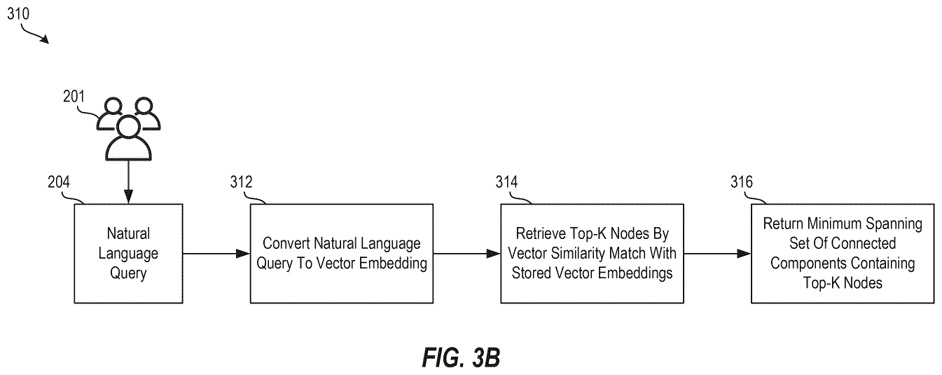

Graph subschema selection 208 receives the natural language query 204 from the user 201 and receives graph schema from the graph database 202. Graph subschema selection 208 identifies a relevant subgraph from the graph schema of the graph database 202 that covers an intent of the natural language query 204. The graph subschema selection 208 uses the graph schema to select the appropriate nodes, relationships, and attributes based on the natural language query 204. Graph subschema selection is described in more detail with reference to FIGS. 3A and 3B.

Query translation and mapping 210 translates the natural language query 204 into a form suitable for querying the graph database 202 by mapping elements of the natural language query 204 to elements of the graph schema received from the graph database 202. Particularly, query translation and mapping 210 maps the natural language query 204 to the corresponding nodes, attributes, and relationships in the identified subschema, which is received from the graph subschema selection 208 as a query-based graph subschema. Query translation and mapping 210 provides query translations based on the query-based graph subschema.

User preference selection 212 incorporates user preferences, such as of the user 201, which define values for identifiers to disambiguate user intent.

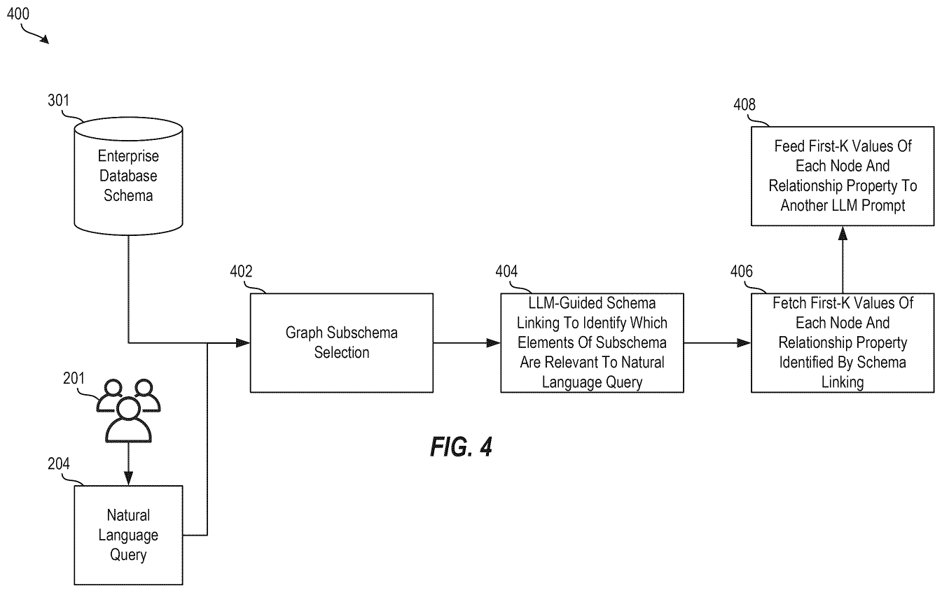

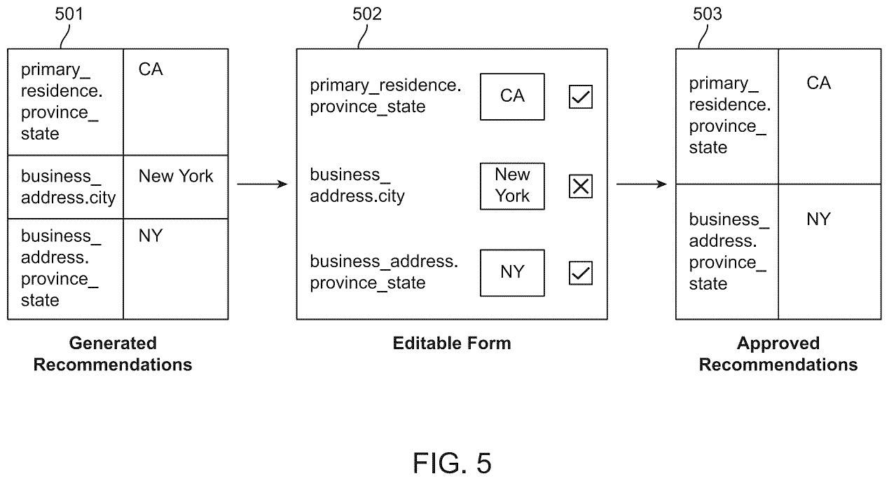

Recommended search values 214 are values from the graph database 202 recommended based on the natural language query 204. For example, elements of the graph schema that the user 201 may want are searched and recommended based on the user preferences of the user 201 by the user preference selection 212. Recommended search values 214 are described in more detail with reference to FIG. 4. An example of the user preference selection 212 is described in more detail with reference to FIG. 5.

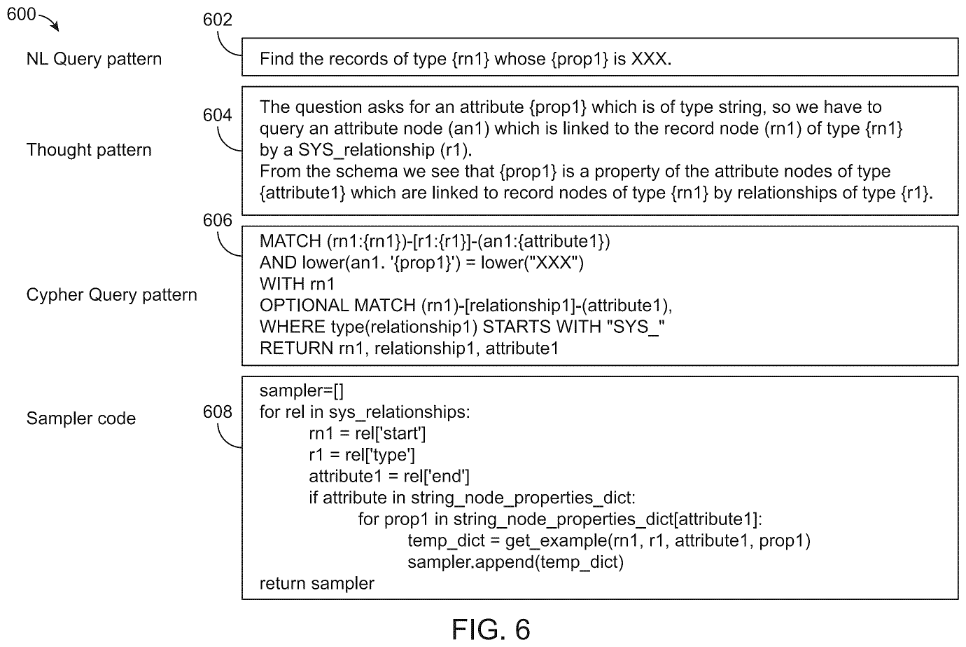

Query pattern fewshot generator 216 generates few-shot examples based on various query patterns, such as retrieval, path-based, and multi-step queries. These examples are stored in the generated fewshot repository 224. An example of generating few-shot examples by query pattern fewshot generator 216 is described in more detail with reference to FIG. 6.

Curated fewshot repository 220 stores fewshots curated from public benchmark fewshots 222.

Dynamic fewshot selector 218 selects relevant few-shot examples from both the curated fewshot repository 220 and the generated fewshot repository 224. Dynamic fewshot selector 218 prioritizes examples based on similarity, coverage, and complexity scores, for example.

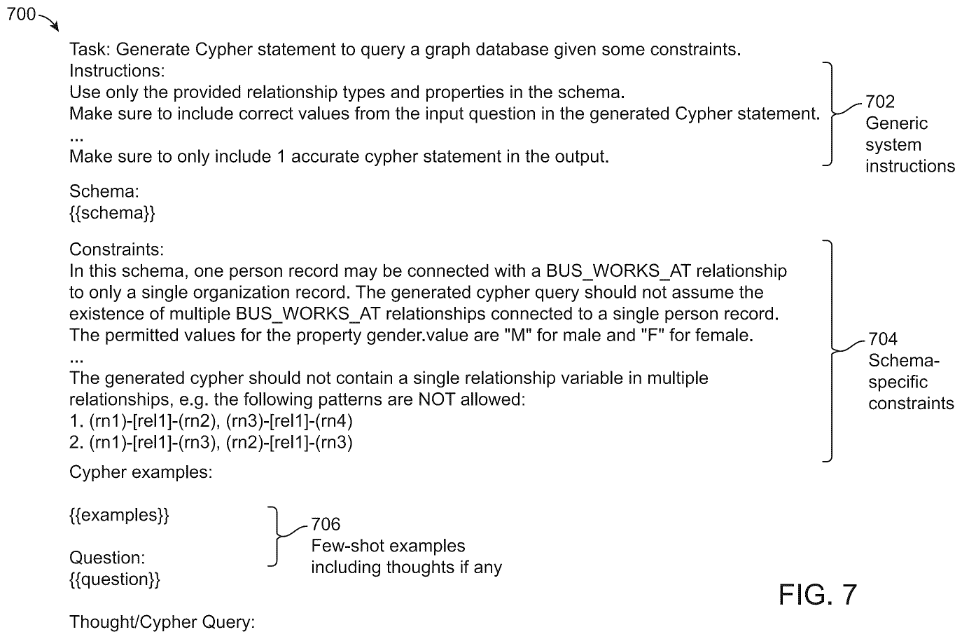

Instruction-based fewshot learning 226 uses the selected few-shot examples from dynamic fewshot selector 218 to guide large language model (LLM) 232 in generating the cypher statement 206. Instruction-based fewshot learning 226 provides instructions and constraints to ensure accurate cypher statement generation. More particularly, instruction-based fewshot learning 226 generates cypher statement prompt that is fed into LLM 232 to cause LLM 232 to generate the cypher statement. An example of instruction-based fewshot learning 226 is described in more detail with reference to FIG. 7.

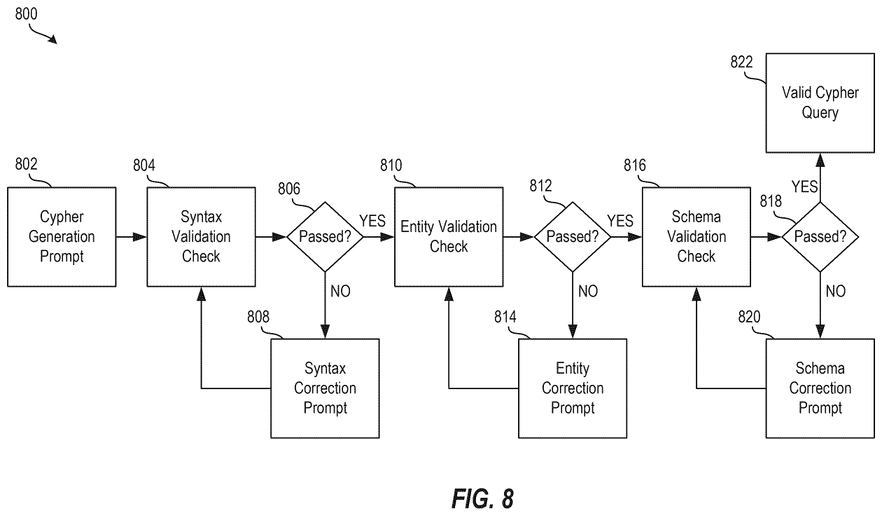

Automatic validation and self-healing 228 validates LLM 232 using validation check 230 to provide course correction of LLM 232. Particularly, automatic validation and self-healing 228 validates the cypher statement prompt that is fed into LLM 232 using validation check 230 to cause LLM 232 to generate the cypher statement. Automatic validation and self-healing 228 can include one or more of syntax validation, entity validation, and schema validation, which are described in more detail herein with reference to FIG. 8.

The validated cypher statement 206, which is generated by LLM 232 based on the cypher statement prompt, is then used to query the graph database 202, and the fetched results are returned to the user 201. The system 200 supports multi-turn conversational interactions, allowing the user 201 to provide follow-up queries and continuously refine the cypher statement 206.

Features and functionality of the system 200 are now described in more detail with reference to FIGS. 3A-10B but are not so limited.

FIG. 3A illustrates flow diagram of a method 300 for offline graph subschema selection, according to an embodiment. The method 300 can be performed by any suitable computing system, device, or environment, such as those described herein. The method 300 is now described with reference to the computing environment 100, and particularly the query engine 150, but is not so limited. For example, the method 300 is performed by the query engine 150.

The method 300 involves several steps to prepare the enterprise database schema for efficient querying. The method 300 begins with the enterprise database schema 301, which contains the overall structure of the graph database 202, including nodes, properties, and relationships. At block 302, the method 300 includes identifying node names and properties of the nodes within the enterprise database schema 301. The identified node names and properties from block 302 are then converted into a string representation for each node at block 304. This step ensures that the node information is in a format suitable for further processing. At block 306, vector embeddings are generated for each string representation of the nodes. These embeddings are numerical representations that capture the semantic meaning of the node names and properties. At block 308, the generated vector embeddings are stored in memory. According to one or more embodiments, this is a one-time operation performed during system reboot, ensuring that the embeddings are readily available for subsequent querying processes. This offline preparation of the enterprise database schema 301 enables efficient and accurate subschema selection during the online querying process.

Additional processes also may be included, and it should be understood that the processes depicted in FIG. 3A represent illustrations, and that other processes may be added or existing processes may be removed, modified, or rearranged without departing from the scope of the present disclosure. It should also be understood that the processes depicted in FIG. 3A may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 3B illustrates flow diagram of a method 310 for online graph subschema selection, according to an embodiment. The method 310 can be performed by any suitable computing system, device, or environment, such as those described herein. The method 310 is now described with reference to the computing environment 100, and particularly the query engine 150, but is not so limited. For example, the method 310 is performed by the query engine 150.

The method 300 involves dynamically selecting a relevant subgraph based on the user's natural language query. The method 300 includes the user 201 providing a natural language query 204, which is directed towards querying the graph database 202. The natural language query 204 is converted into a vector embedding at block 312. This step transforms the natural language query 204 into a numerical representation that can be compared with stored vector embeddings of the nodes. At block 314, the method 300 retrieves the top-K nodes from the stored vector embeddings by performing a vector similarity match. This step identifies the nodes that are most relevant to the natural language query 204 based on their semantic similarity. At block 316, the method 300 returns a minimum spanning set of connected components that contain the top-K nodes. A minimum spanning set of connected components refers to a subset of a graph that includes the smallest number of nodes and edges necessary to cover a specific set of nodes while maintaining connectivity. In the context of graph databases and querying, this concept is used to identify the most relevant subgraph that covers the intent of the natural language query 204. This online method ensures that the system 200 dynamically selects the most relevant subgraph for each natural language query 204, enabling accurate and efficient querying of the enterprise graph database.

Additional processes also may be included, and it should be understood that the processes depicted in FIG. 3B represent illustrations, and that other processes may be added or existing processes may be removed, modified, or rearranged without departing from the scope of the present disclosure. It should also be understood that the processes depicted in FIG. 3B may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 4 illustrates a flow diagram of a method 400 for search value recommendation, according to an embodiment. The method 400 can be performed by any suitable computing system, device, or environment, such as those described herein. The method 400 is now described with reference to the computing environment 100, and particularly the query engine 150, but is not so limited. For example, the method 400 is performed by the query engine 150.

The method 400 involves several steps to generate recommended search values based on the natural language query 204, incorporating user preferences and ensuring the relevance of the query to the graph database schema.

Enterprise database schema 301 represents the overall structure of the graph database 202, including nodes, properties, and relationships. The user 201 provides the natural language query 204, which is directed towards querying the graph database 202.

The natural language query 204 is received at block 402, which involves selecting a graph subschema. In particular, at block 402, the method 400 receives the natural language query 204 and the graph schema from the enterprise database schema 301. The method 400 identifies a relevant subgraph from the graph schema defined in the enterprise database schema 301 that covers the intent of the natural language query 204. This involves selecting the appropriate nodes, relationships, and attributes based on the query.

At block 404, LLM-guided schema linking is performed. In particular, the method 400 uses an LLM to guide schema linking. This includes identifying which elements of the subschema (e.g., node and relationship properties) are relevant to the natural language query 204. This step ensures that the system 200 understands the context and the specific elements that need to be addressed in the query.

At block 406, the method 400 fetches a first set of values (first-K values) for each identified node and relationship property from the graph database 202. These values are relevant to the elements identified by the schema linking process.

At block 408, the method 400 feeds the fetched first-K values of each node and relationship property into another LLM prompt, which recommends likely property values corresponding to the natural language query 204. This step involves generating likely property values corresponding to the natural language query 204 based on the fetched values and the schema linking. The LLM uses these values to generate recommendations for the user. The method 400 ensures that the generated recommendations are accurate and relevant to the natural language query 204, incorporating user preferences and providing intelligent search values to refine the cypher generation prompt generation process.

Consider the following example for the method 400. The natural language query 204 is as follows: “Find people working in New York who live in California.” The linked node properties at block 404 are:
1. primary_residence.province_state
2. business_address.city
3. business_address.province_state
   The following Table 1 defines the first-K values for each node and relationship property identified by schema linking:

TABLE 1

| primary_residence.province_state | business_address.city | business_address.province_state |
|---|---|---|
| WA | Dallas | TX |
| OH | Chicago | IL |

The following Table 2 defines generated recommendations generated by the LLM at block 408:

TABLE 2

| | |
|---|---|
| primary_residence.province_state | CA |
| business_address.city | New York |
| business_address.province_state | NY |

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 5 illustrates tables 501, 503 for user preference selection using an interface, according to an embodiment. In particular, a generated recommendations table 501 is generated using the method 400 of FIG. 4, for example. The generated recommendations are fed into an editable form 502 that enables the user 201 to approve or reject the recommendations in the generated recommendations table 501. The approved recommendations are stored in an approved recommendations table 503 as shown.

FIG. 6 illustrates pseudo-code 600 for query pattern-based fewshot generation, according to an embodiment. This figure provides a detailed breakdown of the components involved in generating few-shot examples based on various query patterns. NL Query Pattern 602 defines a natural language query pattern. In this example, the pattern is “Find the records of type {rn1} whose {prop1} is XXX.” This pattern serves as a template for generating queries that can be used to retrieve specific records from the graph database 202. Thought Pattern 604 provides a thought process or reasoning behind the NL query pattern 602. It explains the logic used to translate the natural language query 204. Cypher Query Pattern 606 provides the corresponding cypher query pattern based on the NL query pattern 602 and the thought pattern 604. Sampler code 608 provides pseudo-code for generating appropriate values for the placeholder variables in the cypher query pattern 606. The sampler code iterates through the SYS_relationships and generates examples based on the identified relationships and properties. This code generates a set of examples based on the relationships and properties defined in the schema, which can be used to create few-shot examples for training the LLM 232. Overall, FIG. 6 provides a framework for generating few-shot examples based on query patterns, which can be used to guide the LLM 232 in generating accurate cypher statements (e.g., the cypher statement 206) for querying the graph database 202.

FIG. 7 illustrates pseudo-code 700 for instruction-based fewshot learning, according to an embodiment. This figure provides a structured approach for generating Cypher statements to query a graph database, given some constraints. Generic system instructions 702 include a task and instructions as shown. Schema-specific constraints 704 provide schema-specific constraints that are to be adhered to when generating the cypher statement 206. Few-hot examples 706, which may include thoughts (if any) provide cypher examples and questions. The cypher examples are few-shot examples, which are specific instances of Cypher statements that adhere to the provided instructions and constraints. These examples serve as a guide for generating new cypher statements. Overall, FIG. 7 provides a comprehensive framework for instruction-based fewshot learning, guiding the LLM 232 in generating accurate cypher statements (e.g., the cypher statement 206) for querying the graph database 202. The structured approach ensures that the generated cypher statements adhere to the schema-specific constraints and include correct values from the input question.

The dynamic fewshot selector 218 automatically selects a relevant set of fewshot examples from the curated fewshot repository 220 and the generated fewshot repository 224. Given a budget of k few-shot examples, the dynamic fewshot selector 218 prioritizes the curated fewshot repository which is populated by user provided examples and examples found from public benchmark for that schema. The dynamic fewshot selector 218 computes the cosine similarity between the input natural language query 204 to a curated fewshot natural language query, and those examples which cross a pre-defined threshold t are selected. In the scenario when the budget is not exhausted by the curated fewshot examples, the pattern-based fewshot examples are utilized. The dynamic fewshot selector 218 identifies a set of fewshot examples from the curated fewshot repository 220 based on the similarity score as well as a coverage score (which identifies if the fewshots are selected from various query types) and complexity score (which ensures diversity in the complexity of the generated patterns). The similarity scores for pattern-based fewshot examples are compared with the output of the schema-linking or user preference selection corresponding to the input natural language query 204. The coverage and complexity scores are computed on the set of pattern-based fewshot examples that are selected. According to one or more embodiments, the set that maximizes the sum of all scores is selected.

FIG. 8 illustrates a flow diagram of a method 800 for performing self-healing validation, according to an embodiment. The method 800 can be performed by any suitable computing system, device, or environment, such as those described herein. The method 800 is now described with reference to the computing environment 100, and particularly the query engine 150, but is not so limited. For example, the method 400 is performed by the query engine 150.

The method 800 for involves multiple validation steps to ensure the generated cypher statement 206 is accurate and adheres to the schema, syntax, and entity requirements. The components and steps involved in the method are as follows:

At block 802, a cypher generation prompt is generated based on the natural language query 204 and the identified subgraph. The cypher generation prompt is used to prompt LLM 232 to generate the cypher statement 206. This cypher generation prompt is then subjected to a series of validation checks (e.g., validation check 230).

At block 804, a syntax validation check is performed, which involves checking the syntax of the cypher generation prompt. This step ensures that the cypher generation prompt adheres to the correct cypher syntax rules.

At decision block 806 it is determined whether the cypher generation prompt has passed the syntax validation check at block 804. If the check fails, the method 800 proceeds to the syntax correction prompt 808. That is, if the cypher generation prompt fails the syntax validation check, a syntax correction prompt is generated. This prompt is used to correct the syntax errors in the cypher generation prompt, and the corrected query is then re-validated. More particularly, the syntax validation check at block 804 utilizes a cypher compiler to perform the syntax validation. The cypher generation prompt is fired on a dummy graph database and is checked for a syntax error response from the cypher compiler. The syntax error message is stored so that it can be passed to the LLM 232 as a part of a prompt for syntax correction which regenerates the cypher statement 206. The cypher generation prompt includes: a system instruction (e.g., “Correct the syntax of the following cypher generation prompt based on the provided error message.”), the incorrect cypher generation prompt, and the syntax error message from the cypher compiler. The method 800 iterates with the regenerated cypher generation prompt until the syntax validation check at block 804 is passed at decision block 806. If the cypher generation prompt passes, the method 800 moves to the next validation step at block 810.

At block 810, the method 800 performs an entity validation check at block 810. Once the cypher generation prompt passes the syntax validation check at block 804, the cypher generation prompt undergoes an entity validation check. This step ensures that the entities referenced in the cypher generation prompt are accurate and correctly mapped to the schema. The entities are extracted from the input natural language query 204 through standard entity processing models in named entity recognition approaches. The set of mapped entities and corresponding linked schema nodes, attribute values and relationship values are identified. The cypher generation prompt is parsed to identify the entities that are included in the cypher generation prompt along with the node/attribute values and relationship values. The entity validation check at block 810 checks for each entity and its corresponding node, attribute or relationship value associated with it and if it matches with the set of entities linked with the schema from the user input query. For the set of incorrect matches or missing matches, the entity validation check at block 810 invokes the LLM 232 prompted with few-shot learning to correct the incorrect cypher generation prompt given the identified set of incorrect matches and missing matches. The generated cypher generation prompt is again sent to the entity validation check at block 810 in an iterative fashion until it passes the entity validation check at block 810 at decision block 812 and generated an entity-corrected cypher statement, which is passed to a schema validation check at block 816. At decision block 812, it is determined whether the cypher generation prompt has passed the entity validation check at block 810. If the cypher generation prompt fails, the method proceeds to the entity correction prompt at block 814. If the cypher generation prompt passes, the method 800 moves to the next validation step by performing a schema validation check at block 816.

At block 816, once the cypher generation prompt passes the entity validation check at decision block 812, it undergoes a schema validation check at block 816. This step ensures that the query adheres to the schema structure, including the correct relationships and properties. A cypher parser is used to extract a referenced node and relationship variables along with the corresponding types and properties in the cypher generation prompt, as well as relationship triples (start node type, relationship type, end node type). A list of node and relationship types, the corresponding properties in the graph subschema, and relationship triples are also received according to one or more embodiments.

(start node type, relationship type, end node type). For each extracted relationship triple in the cypher generation prompt: Case 1: If any one or both the start and end node types along with the relationship type are found in the parsed cypher generation prompt, it is determined whether such a relationship exists in the subschema; or Case 2: In all other scenarios, it is determined whether the corresponding node and relationship types in the subschema are referenced in the cypher generation prompt. For each node variable in the cypher statement, if the node type is found in the parsed cypher generation prompt, it is determined whether the node type exists and the referenced properties are indeed present as node properties of the corresponding node type in the subschema. For each relationship variable in the cypher statement, if the relationship type is found in the parsed cypher, it is determined whether the relationship type exists and the referenced properties are indeed present as relationship properties of the corresponding relationship type in the subschema. For each failed check, custom error messages are generated based on predefined templates and stored in memory. If at least one of the above checks fails, the stored error message(s) are passed to the LLM 232 as part of a prompt for schema correction which regenerates the cypher generation prompt. The prompt for schema correction includes: a system instruction (e.g., “The following cypher generation prompt is erroneous because it does not conform to the schema of the graph. Given the schema of the graph and the provided error messages, please generate a correct cypher generation prompt.”), the subschema of the graph in text format, the incorrect cypher generation prompt, and the stored error message(s). The method 800 partially iterates with the regenerated cypher generation prompt until the schema validation check is passed at decision block 818. Particularly, at decision block 818, it is determined whether the cypher generation prompt has passed the schema validation check at block 816. If the cypher generation prompt passes, it is considered a valid cypher generation prompt. If it fails, the method 800 proceeds to the schema correction prompt 820.

At block 822, once the cypher generation prompt passes all the validation checks (syntax validation check at block 804, entity validation check at block 810, and schema validation check at block 816), the cypher generation prompt is considered a valid cypher generation prompt. This validated cypher generation prompt can then be used to generate the cypher statement 206, which is used query the graph database 202 and fetch the desired results.

The method 800 ensures that the generated cypher generation prompt is accurate and adheres to all necessary validation checks, providing a robust self-healing mechanism to correct any errors iteratively.

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

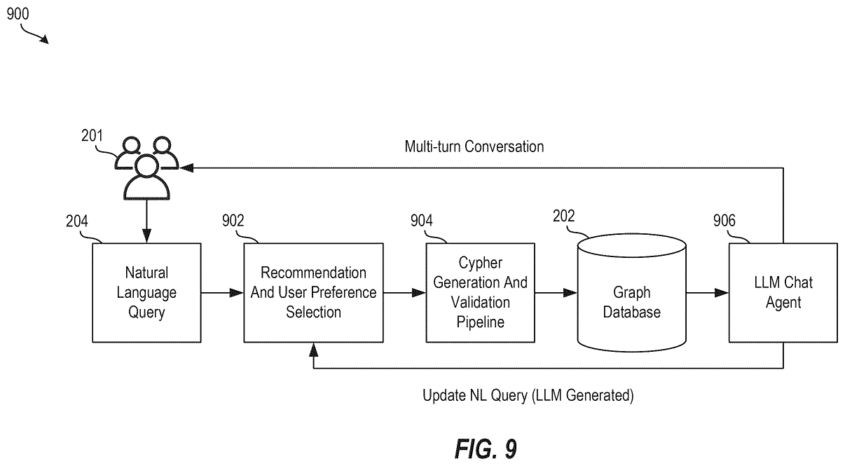

FIG. 9 illustrates a flow diagram of a method 900 for conversational search of a graph database, according to an embodiment. The method 900 can be performed by any suitable computing system, device, or environment, such as those described herein. The method 900 is now described with reference to the computing environment 100, and particularly the query engine 150, but is not so limited. For example, the method 400 is performed by the query engine 150.

FIG. 9 illustrates a flow diagram of a method 900 for conversational search of a graph database, according to an embodiment. This method involves multiple components and steps to process the natural language query 204 and generate the Cypher statement 206 to query the graph database 202. The method 900 further provides for iteratively refining the cypher statement 206 through multi-turn conversations. The components and steps involved in the method 900 are now described in more detail.

The method 900 begins with the user 201 providing the natural language query 204. This query is directed towards performing a search on the graph database 202. At block 902, the natural language query 204 is used for recommendation and user preference selection. This block incorporates user preferences and provides recommendations to disambiguate the user's intent. It ensures that the natural language query 204 is tailored to the user's specific needs and preferences.

At block 904, a cypher generation and validation pipeline is implemented. This pipeline generates the cypher statement 206 as described herein based on the natural language query 204 and validates it through multiple steps, including syntax validation, entity validation, and schema validation. The validation ensures that the generated cypher statement 206 is accurate and adheres to the schema of the graph database 202.

The cypher statement 206, which is validated at block 904, is then used to query the graph database 202. The graph database 202 contains the nodes, relationships, and properties relevant to the user's query.

Results of the query are processed by LLM chat agent 906, which facilitates multi-turn conversational interactions with the user 201. LLM chat agent 906 allows the user 201 to provide follow-up queries in natural language and continuously refine the cypher statement 206 based on the results and additional user input. This allows for updating the natural language query 204 using LLM-generated information.

The method 900 supports multi-turn conversations, enabling the user 201 to iteratively refine their natural language query. The LLM chat agent 906 updates the natural language query based on the user's feedback in a conversional form and generates new cypher statements as appropriate. This iterative process continues until the user 201 is satisfied with the query results.

Overall, FIG. 9 depicts a comprehensive workflow for dynamic context-based conversational search over an enterprise graph database. The method 900 leverages user preferences, automated query generation, and multi-turn interactions to provide accurate and efficient querying of the graph database.

Additional processes also may be included, and it should be understood that the processes depicted in FIG. 9 represent illustrations, and that other processes may be added or existing processes may be removed, modified, or rearranged without departing from the scope of the present disclosure. It should also be understood that the processes depicted in FIG. 9 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

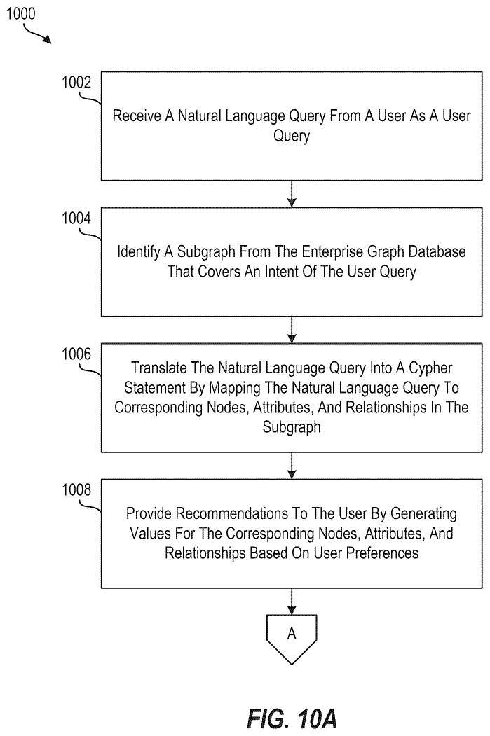

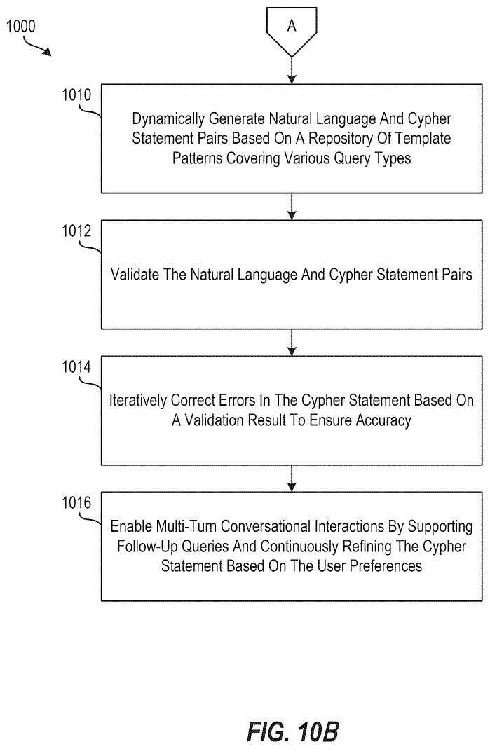

FIGS. 10A and 10B together depict a flow diagram of a method 1000 for dynamic context-based conversational search over enterprise graph databases is provided, according to an embodiment. The method 1000 can be performed by any suitable computing system, device, or environment, such as those described herein. The method 1000 is now described with reference to the computing environment 100, and particularly the query engine 150, but is not so limited. For example, the method 1000 is performed by the query engine 150.

FIG. 10A illustrates the first part of a flow diagram of a method 1000 for dynamic context-based conversational search over an enterprise graph database. The method involves several steps to process a natural language query and generate a corresponding Cypher statement. The steps are as follows:

At block 1002, the method 1000 includes the query engine 150 receiving a natural language query from a user as a user query. This query is directed towards performing a search on the graph database.

At block 1004, the method 1000 includes the query engine 150 identifying a subgraph from the enterprise graph database that covers the intent of the user query. This involves selecting the appropriate nodes, relationships, and attributes based on the query.

At block 1006, the method 1000 includes the query engine 150 translating the natural language query by mapping the natural language query to corresponding nodes, attributes, and relationships in the identified subgraph.

At block 1008, the method 1000 includes the query engine 150 providing recommendations to the user by generating values for the corresponding nodes, attributes, and relationships in the subgraph. These recommendations help disambiguate the user's intent and refine the query.

With reference to FIG. 10B, at block 1010, the method 1000 includes the query engine 150 dynamically generating a Cypher statement based on a repository of template patterns covering various query types. This step ensures that the generated queries are relevant and accurate.

At block 1012, the method 1000 includes the query engine 150 validating the generated Cypher statement. This validation step ensures that the Cypher statement adhere to the correct syntax, entity mappings, and schema structure.

At block 1014, the method 1000 includes the query engine 150 iteratively correcting errors in the Cypher statement based to ensure correctness. This self-healing process minimizes the risk of query failures and enhances the reliability of the querying process.

At block 1016, the method 1000 includes the query engine 150 enabling multi-turn conversational interactions by supporting follow-up queries and continuously refining the Cypher statement based on user preferences. This interactive approach improves the user experience and enables more precise data retrieval.

Overall, FIGS. 10A and 10B together depict a comprehensive workflow for dynamic context-based conversational search over an enterprise graph database, leveraging user preferences, automated query generation, validation, and multi-turn interactions to provide accurate and efficient querying.

Additional processes also may be included, and it should be understood that the processes depicted in FIGS. 10A and 10B represent illustrations, and that other processes may be added or existing processes may be removed, modified, or rearranged without departing from the scope of the present disclosure. It should also be understood that the processes depicted in FIGS. 10A and 10B may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein improves the functioning of a computer by enhancing the efficiency, accuracy, and user-friendliness of querying enterprise graph databases through dynamic context-based conversational search. Examples of some improvements of one or more embodiments are as follows.

One or more embodiments provides automated query generation. For example, one or more embodiments automates the generation of cypher statements from natural language inputs, reducing the need for manual query writing. This automation streamlines the querying process, making it faster and more accessible to users who may not be proficient in cypher or other query languages. By reducing the manual effort required, one or more embodiments allows the computer to handle more queries in less time, improving overall throughput.

One or more embodiments provides dynamic subgraph selection: For example, by dynamically identifying and selecting a relevant subgraph from the enterprise graph database based on the user's query, one or more embodiments ensures that only the necessary portions of the database are queried. This targeted approach reduces computational overhead and improves query performance. The computer can process queries more efficiently by focusing on smaller, relevant subsets of the data, leading to faster response times and reduced resource consumption.

One or more embodiments provides user preference incorporation. For example, one or more embodiments incorporates user preferences into the cypher statement generation process, providing personalized recommendations and refining the cypher statement based on user feedback. This customization enhances the relevance and accuracy of the query results, leading to more efficient data retrieval. By tailoring the cypher statements to user preferences, one or more embodiments reduces the need for repeated queries and manual adjustments, optimizing the computer's processing capabilities.

One or more embodiments provides few-shot learning and pattern-based generation. For example, the use of few-shot learning and pattern-based query generation allows one or more embodiments to generate accurate cypher statements even for complex and varied query types. This capability improves the ability to handle diverse querying scenarios and reduces the need for extensive training data. The computer can leverage pre-defined patterns and examples to generate queries quickly and accurately, enhancing its ability to adapt to new and complex data structures.

One or more embodiments provides self-healing validation pipeline. For example, the self-healing validation pipeline ensures that the generated cypher statements are syntactically correct, semantically accurate, and conform to the database schema. By iteratively correcting errors in the queries, one or more embodiments minimizes the risk of query failures and enhances the reliability of the querying process. This validation process reduces the need for manual error correction, allowing the computer to autonomously ensure the accuracy and integrity of the queries.

One or more embodiments provides multi-turn conversational interactions. For example, one or more embodiments supports multi-turn conversational interactions, allowing users to refine their queries through follow-up questions and feedback. This interactive approach improves the user experience and enables more precise data retrieval. The computer can maintain context and continuity across multiple interactions, providing more accurate and relevant responses over time.

One or more embodiments provides efficient resource utilization. For example, by optimizing the query generation and validation processes, one or more embodiments reduces the computational resources required for querying large and complex graph databases. This efficiency leads to faster query execution times and lower resource consumption, improving the overall performance of the computer system. The computer can handle more queries simultaneously and operate more cost-effectively by minimizing resource usage.

Overall, one or more embodiments enhances the functioning of a computer by providing a robust, efficient, and user-friendly solution for querying enterprise graph databases. The combination of automated query generation, dynamic subgraph selection, user preference incorporation, few-shot learning, self-healing validation, and conversational interactions results in a significant improvement in the accuracy, efficiency, and reliability of the querying process for graph databases. These enhancements enable the computer to process complex queries more effectively, deliver faster and more accurate results, and provide a better user experience.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for dynamic context-based conversational search over an enterprise graph database, the method comprising:
receiving a natural language query from a user as a user query;
identifying a subgraph from the enterprise graph database that covers an intent of the user query;
translating the natural language query by mapping the natural language query to corresponding nodes, attributes, and relationships in the subgraph;
providing recommendations to the user by generating values for the corresponding nodes, attributes, and relationships in the subgraph;
dynamically generating a cypher statement based on a repository of template patterns covering various query types; and
iteratively correcting errors in the generated cypher statement to ensure correctness.

2. The computer-implemented method of claim 1, wherein the operations further comprise validating the generated cypher statement.

3. The computer-implemented method of claim 2, wherein validating the generated cypher statement comprises performing a multi-step validation pipeline.

4. The computer-implemented method of claim 3, wherein the multi-step validation pipeline comprises performing a syntax validation, an entity validation, and a schema validation.

5. The computer-implemented method of claim 1, further comprising enabling multi-turn conversational interactions by supporting follow-up queries and continuously refining the cypher statement based on user preferences.

6. The computer-implemented method of claim 1, wherein providing the recommendations to the user is generated through a mapping of the natural language query to a subgraph in a graph schema of the enterprise graph database.

7. The computer-implemented method of claim 6, wherein the recommendations provided to the user comprise search values utilizing the corresponding nodes, attributes, and relationships in the subgraph.

8. The computer-implemented method of claim 6, wherein the recommendations provided to the user comprise natural language query translations of the natural language query utilizing the corresponding nodes, attributes, and relationships in the subgraph.

9. A computer system comprising:
a processor set;
one or more computer-readable storage media; and
program instructions stored on the one or more computer-readable storage media to cause the processor set to perform operations for dynamic context-based conversational search over an enterprise graph database, the operations comprising:
receiving a natural language query from a user as a user query;
identifying a subgraph from the enterprise graph database that covers an intent of the user query;
translating the natural language query by mapping the natural language query to corresponding nodes, attributes, and relationships in the subgraph;
providing recommendations to the user by generating values for the corresponding nodes, attributes, and relationships in the subgraph;
dynamically generating a cypher statement based on a repository of template patterns covering various query types; and
iteratively correcting errors in the generated cypher statement to ensure correctness.

10. The computer system of claim 9, wherein the operations further comprise validating the generated cypher statement.

11. The computer system of claim 10, wherein validating the generated cypher statement comprises performing a multi-step validation pipeline.

12. The computer system of claim 11, wherein the multi-step validation pipeline comprises performing a syntax validation, an entity validation, and a schema validation.

13. The computer system of claim 9, wherein the operations further comprise enabling multi-turn conversational interactions by supporting follow-up queries and continuously refining the cypher statement based on user preferences.

14. The computer system of claim 9, wherein providing the recommendations to the user is generated through a mapping of the natural language query to a subgraph in a graph schema of the enterprise graph database.

15. The computer system of claim 14, wherein the recommendations provided to the user comprise search values utilizing the corresponding nodes, attributes, and relationships in the subgraph.

16. The computer system of claim 14, wherein the recommendations provided to the user comprise natural language query translations of the natural language query utilizing the corresponding nodes, attributes, and relationships in the subgraph.

17. A computer program product comprising:
one or more computer-readable storage media; and
program instructions stored on the one or more computer-readable storage media to perform operations for dynamic context-based conversational search over an enterprise graph database, the operations comprising:
receiving a natural language query from a user as a user query;
identifying a subgraph from the enterprise graph database that covers an intent of the user query;
translating the natural language query by mapping the natural language query to corresponding nodes, attributes, and relationships in the subgraph;
providing recommendations to the user by generating values for the corresponding nodes, attributes, and relationships in the subgraph;
dynamically generating a cypher statement based on a repository of template patterns covering various query types; and
iteratively correcting errors in the generated cypher statement to ensure correctness.

18. The computer program product of claim 17, wherein the operations further comprise validating the generated cypher statement.

19. The computer program product of claim 18, wherein validating the generated cypher statement comprises performing a multi-step validation pipeline.

20. The computer program product of claim 19, wherein the multi-step validation pipeline comprises performing a syntax validation, an entity validation, and a schema validation.
